(19) United States
(12) Patent Application Publication
(10) Pub. No.: US 2021/0292153 A1
(43) Pub. Date: Sep. 23, 2021

(54) SYSTEM FOR PROVIDING AUTOMATED BOTTLED WATER REORDERING SERVICE

(71) Applicant: Kuang F CHENG, Taipei City (TW)

(72) Inventor: Kuang F CHENG, Taipei City (TW)

(21) Appl. No.: 17/339,753

(22) Filed: Jun. 4, 2021

Related U.S. Application Data
(63) Continuation-in-part of application No. 17/101,980, filed on Nov. 23, 2020.
Application No. 17/101,980 is a continuation-in-part of application No. 16/158,285, filed on Oct. 11, 2018, now abandoned.
Application No. 16/158,285 is a continuation-in-part of application No. 17/103,188, filed on Nov. 24, 2020.
Application No. 17/103,188 is a continuation-in-part of application No. 16/158,285, filed on Oct. 11, 2018, now abandoned.
Application No. 16/158,285 is a continuation-in-part of application No. 15/952,260, filed on Apr. 13, 2018, now abandoned.
Application No. 15/952,260 is a continuation-in-part of application No. 16/856,063, filed on Apr. 23, 2020, now abandoned.
Application No. 16/856,063 is a continuation of application No. 15/978,201, filed on May 14, 2018, now abandoned.

(51) Int. Cl. B67D 3/00; G01F 23/20

(52) U.S. Cl. CPC B67D 3/0032; B67D 1/0009; G01F 23/20

(57) ABSTRACT

A system is described for providing automated bottled water reordering service based on monitored usage. The system comprises a water dispenser, a sensor and a server. The water dispenser is connected with a replaceable bottled water for supplying a drinking water from the bottled water. The sensor monitors a drinking water consumption in the water dispenser. The server receives a data associated with the drinking water consumption from the sensor and then determines whether a trigger event has occurred by comparing the drinking water consumption with a reference. After the trigger event has occurred, The server sends a replenishment message to a customer device for the customer to confirm whether or not to place a replenishment order of a bottled water delivery service.

### CROSS REFERENCE TO RELATED APPLICATIONS

This application is a continuation-in-part application of U.S. patent application Ser. No. 17/101,980, filed on Nov. 23, 2020, which is a continuation-in-part application of U.S. patent application Ser. No. 16/158,285, filed on Oct. 11, 2018. This application is also a continuation-in-part application of U.S. patent application Ser. No. 17/103,188, filed on Nov. 24, 2020, which is a continuation-in-part application of U.S. patent application Ser. No. 16/158,285, filed on Oct. 11, 2018, U.S. patent application Ser. No. 15/952,260, filed on Apr. 13, 2018 and U.S. patent application Ser. No. 16/856,063, filed on Apr. 13, 2020, which is a continuation of U.S. patent application Ser. No. 15/978,201, filed on May 14, 2018. The contents of all of these documents are hereby incorporated herein by reference.

### FIELD OF THE INVENTION

The present disclosure relates generally to a bottled water reordering service and more specifically to an automated bottled water reordering service based on monitored usage.

### BACKGROUND OF THE INVENTION

Drinking water refers to the water that meets the required quality standards and safe for drinking, food preparation, personal hygiene and so on. Currently, water plants provide services for directly supplying drinking water to homes, offices, or other places (usually in packaged bottles). However, generally, water plants are far away from where the customer located, and thus a long distance of transportation is needed. Furthermore, sometimes the water plants prefer to send a water tank only when a specific amount of orders is reached. Therefore, the overall operations are not economic and efficient.

In areas having higher population density, water stations are installed in various locations. Water plants supply water to water stations, the customer can go to the water stations to buy water, but the customer needs take longer time to take water by himself or herself Generally, bottled water is heavy and also a burden for the customer and thus the quantity of water to be transported is limited. Therefore, this way is only suitable to the customer who needs a small quantity.

Furthermore, many users use water dispensers to store and dispense drinking water. Bottled water dispensers typically use 3 gallon or 5 gallon bottle on top of the unit. If water in the bottle ran out, the empty bottle is taken down from the water dispenser and another one is installed therein. It may give rise to a problem that the bottled water supplier cannot readily know how much water or how many bottled water have been used by the customer. Thus the timing for place a next order for purchasing water would be hard to predict.

### SUMMARY OF THE INVENTION

According to an aspect, there is disclosed a network computer system for providing bottled water delivery service based on monitored usage, comprising: one or more processors of a network-accessible server; and one or more memory resources storing program instructions when executed on the one or more processors, cause the server to: receive, from a sensor which is adapted to monitor a drinking water consumption in a water dispenser of a customer, data associated with the drinking water consumption; determining whether a trigger event has occurred by comparing the drinking water consumption with a reference; after the trigger event has occurred, sending a replenishment message to a customer device for the customer to confirm whether or not to place a replenishment order; receiving data associated with the replenishment order, wherein the replenishment order indicating a customer information, a destination location, a quantity of bottled water and a type of water for the bottled water delivery service; determining a pool of candidate delivery drivers that can satisfy a criterion based on a current location of the candidate delivery drivers, a capacity of a vehicle of the candidate delivery drivers, locations of a plurality of available collection, storing and distribution devices and the destination location, wherein the collection, storing and distribution devices being situated at a particular location where the candidate delivery drivers can access and exchange bottled water; and providing an instruction, according to the replenishment order, to a device of a selected delivery driver to dispatch the selected delivery driver with a particular vehicle to a designated collection, storing and distribution device and then a designated destination location after fetching bottled water from the designated collection, storing and distribution device.

According to an aspect, there is disclosed a system for providing bottled water delivery service based on monitored usage, comprising: a water dispenser connected with a replaceable bottled water for supplying a drinking water from the bottled water; a sensor which is adapted to monitor a drinking water consumption through a passage between the bottled water and the water dispenser; a server communicatively connected to the sensor, the server including one or more processors and one or more memory resources storing program instructions when executed on the one or more processors, perform operations comprising: receiving a data associated with the drinking water consumption from the sensor; determining whether a trigger event has occurred by comparing the drinking water consumption with a reference; after the trigger event has occurred, sending a replenishment message to a customer device for the customer to confirm whether or not to place a replenishment order of a bottled water delivery service.

According to an aspect, there is disclosed a network computer system for providing bottled water delivery service based on monitored usage, comprising: one or more processors of a network-accessible server; and one or more memory resources storing program instructions when executed on the one or more processors, cause the server to: receive, from a sensor which is adapted to monitor a drinking water consumption in a water dispenser of a customer, data associated with the drinking water consumption; determining whether a trigger event has occurred by comparing the drinking water consumption with a reference; after the trigger event has occurred, sending a replenishment message to a customer device for the customer to confirm whether or not to place a replenishment order of a bottled water delivery service.

### BRIEF DESCRIPTION OF THE DRAWINGS

FIG. 1 illustrates a block diagram of the system according to one or more embodiments.

FIG. 2A through FIG. 2D illustrate an example for the bottled water delivery in the automated bottled water reordering service, according to one or more embodiments.

FIG. 3 illustrates an example of the collection, storing and distribution devices, according to one or more embodiments.

FIG. 4 illustrates an example for the automated bottled water reordering service, according to one or more embodiments.

FIG. 5 illustrates a flow diagram of an example for the automated bottled water reordering service, according to one or more embodiments.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

In the following description, numerous details are set forth to provide an understanding of the present disclosure. However, it will be understood by those skilled in the art that the present disclosure may be practiced without these details and that numerous variations or modifications from the described embodiments may be possible.

The terms used in the description of various embodiments are only for the purpose of describing specific examples, and are not intended to be limiting. Unless the context clearly indicates otherwise, or does not deliberately limit the quantity of the assembly, the singular forms “a”, “an” and “the” used herein also include plural forms. On the other hand, the terms “comprising” and “including” are intended to be included, meaning that there may be additional assemblies other than the listed assemblies.

It should be understood that the description order of various embodiments should not be explained as implying that the operations or steps must be dependent on the order, and alternative embodiments may use the order different from the order described herein to perform the steps, operations, methods, etc.

The following terms as used herein have the meanings indicated.

The term “transport driver” refers to a transport provider hired or dispatched by a vendor of bottled water to transport a large amount of bottled waters from a water plant to an intermediate station for temporarily storing. In an example, the transport driver can be individual truck owners, or an entity that controls a fleet of vehicles.

The term “delivery driver” refers to a person who drives or intends to imminently drive or otherwise control operation of the vehicle.

The term “customer device”, “delivery driver device”, and/or “mobile device” refer to devices corresponding to desktop computers, cellular devices or smartphones, personal digital assistants (PDAs), laptop computers, tablet devices, etc., that can provide network connectivity and processing resources for communicating with the system over one or more networks. The customer device and the delivery driver device can each operate a designated service application (e.g., a customer application and a delivery driver application, respectively) that is configured to communicate with the system or the processor. The delivery driver device can also correspond to a computing device that is installed in or incorporated with a vehicle, such as part of the vehicle's on-board computing system.

One or more embodiments described herein may be implemented through the use of instructions that are executable by one or more processors. These instructions may be carried on one or more non-transitory computer-readable mediums. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as flash memory (such as carried on smartphones, multifunctional devices, or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

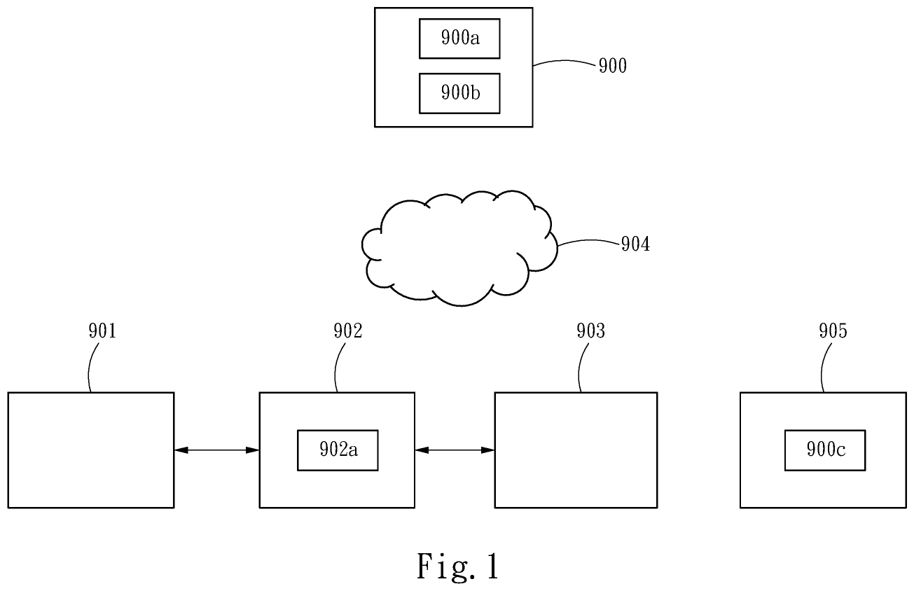

The present disclosure provides a system and method for a automated bottled water reordering service based on monitored usage. FIG. 1 illustrates an example for the system which includes a network-accessible server 900, a water dispenser 901 and a sensor 902, the water dispenser 901 is connected with a replaceable bottled water 903 for supplying a drinking water from the bottled water 903. The sensor 902 is adapted to monitor a drinking water consumption of the bottled water 903 mounted on the water dispenser 901. The sensor 902 may be a flowmeter. In an example, the flowmeter may be installed either on a pipeline connected between the bottled water 903 and the water dispenser 901 or at an outlet port of the water dispenser 901 so as to measure the drinking water consumption.

In the embodiment, the sensor 902 may further includes a wireless connection module 902a to communicatively connected to the server 900 such that the server 900 and the sensor 902 may receive and transmit the data via a wireless interface. The wireless interface utilizes a protocol of at least one of a LoRaWAN, Bluetooth, WiFi, NFC, RFID, 3G, 4G, 5G, LTE or combinations thereof. In the embodiment, the server 900 is connected with the sensor 902 over a network 904. The server 900 includes one or more processors 900a and one or more memory resources 900b storing program instructions.

In operation, the flowmeter monitors the drinking water consumption of the bottled water 903 and sends a data back to the server 900, which is associated with the drinking water consumption. The server 900 then determines whether a trigger event has occurred by comparing the drinking water consumption with a reference. In the example, the trigger event occurs if a difference between the drinking water consumption and the reference is less than a threshold. After the trigger event has occurred, the server 900 sends a replenishment message 900c to a customer device 905 for the customer to confirm whether or not to place a replenishment order to reorder the bottled water before running out.

The reference and/or the threshold may be set by the customer or the service provider. In the example, the reference may be a percentage of the total volume of the bottled waters in the pervious order and the threshold is zero. For a instance, if the first order of the bottled water made by the customer is five bottles of drinking water with a total volume of 25 gallon. Then when the drinking water consumption reaches the reference (e.g. 80% of 25 gallon), the server 900 will send the replenishment message (acts as a reminder for reordering notification) 900c to the customer device 905 for the customer to confirm whether or not to place the replenishment order.

In the embodiment, the automated bottled water reordering service is provided and operated by a service provider. A customer can place an order with the service provider to purchase a selected number of the bottled waters by using the customer device 905 or any other electronic device that can connect to the server 900.

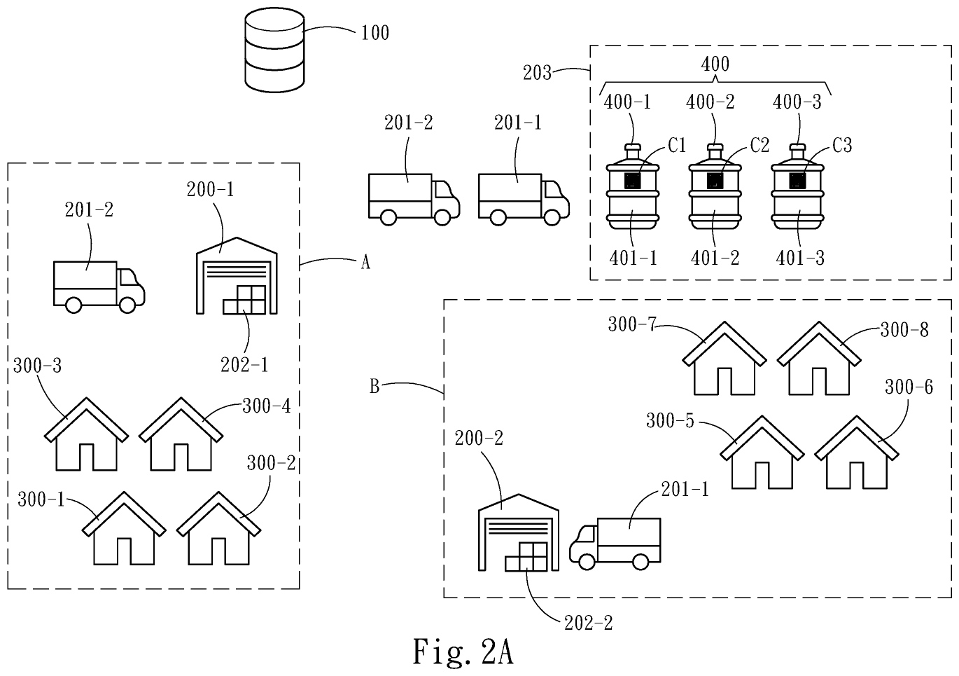

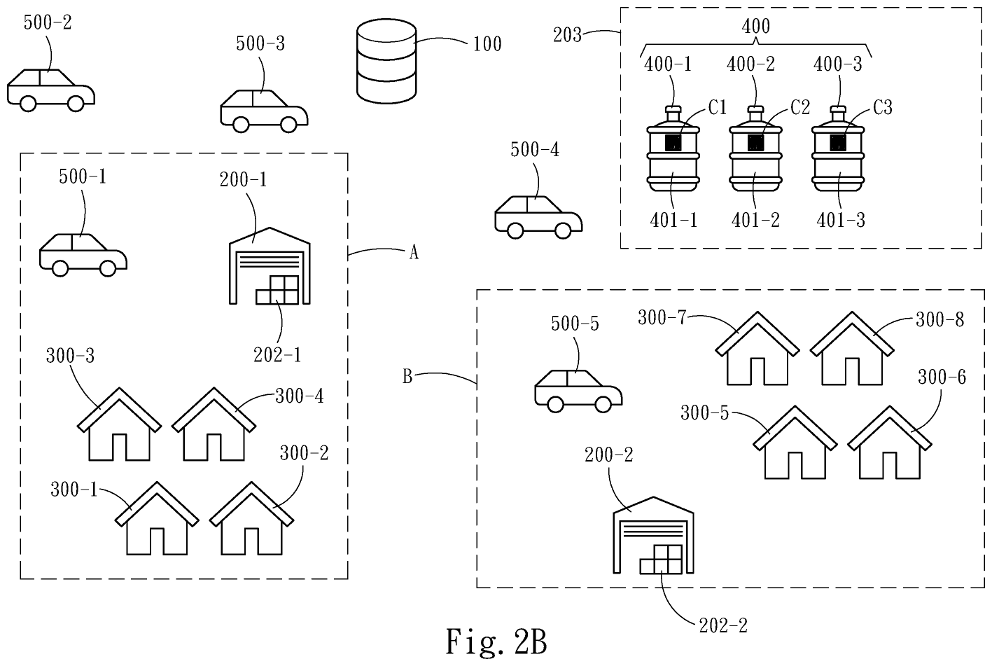

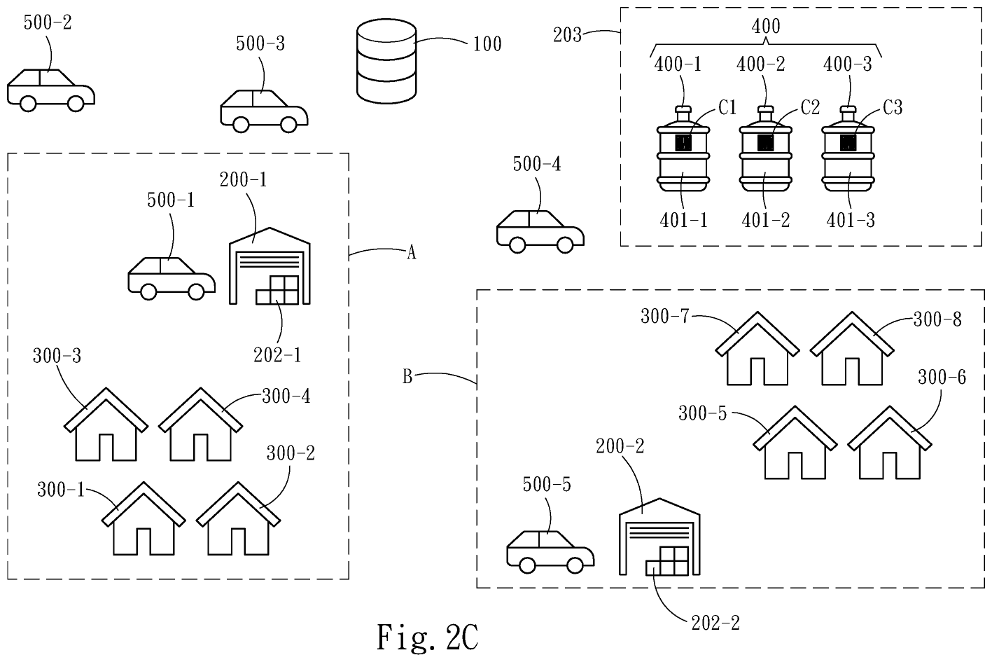

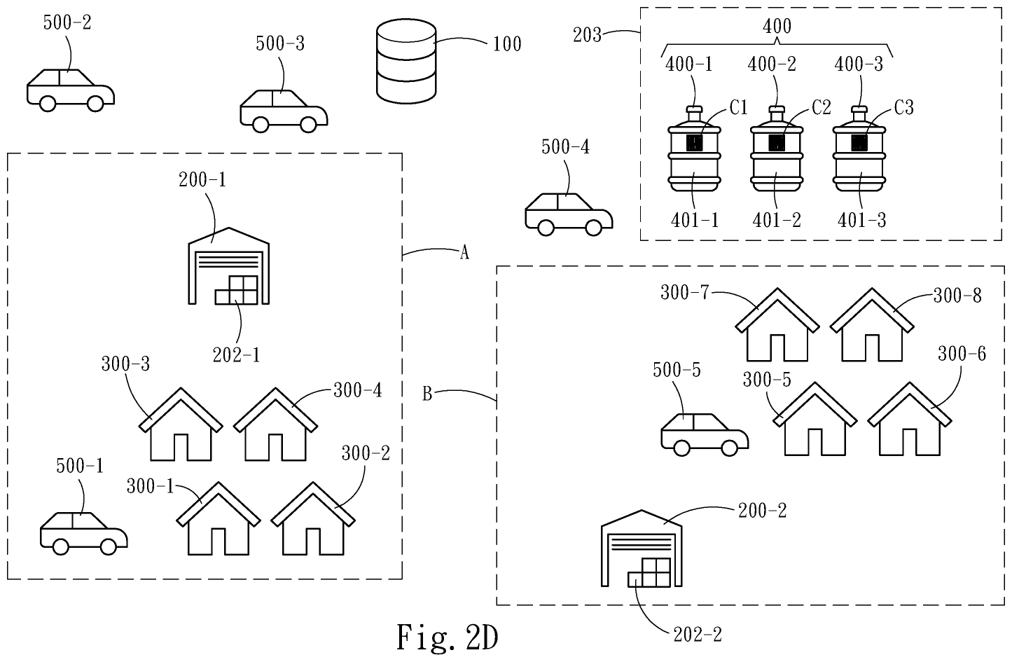

FIG. 2A through FIG. 2D illustrate an example for the bottled water delivery in the automated bottled water reordering service, according to one or more embodiments and also show the relationship between the service provider, the customer, the transport driver and the delivery driver. The example such as shown with FIG. 2A through FIG. 2D may be implemented using, for example, a server or a combination of servers, communicating with mobile computing devices carried by the service providers and the users for the bottled water delivery service. In variations, some or all the functionality described with the system may be implemented using a distributed computing environment, such as provided by client computers and/or mobile computing devices which communicate with the network service.

The architecture of the system described in FIG. 2A through FIG. 2D includes a network-accessible server 100, a plurality of collection, storing and distribution devices 200-1, 200-2, a plurality of trucks 201-1, 201-2, a water source 203, a plurality of destination locations 300-1, 300-2, 300-3, 300-4, 300-5, 300-6, 300-7, 300-8, a plurality of bottled waters 400-1, 400-2, 400-3, a plurality of vehicles 500-1, 500-2, 500-3, 500-4, 500-5. In the present disclosure, each of the plurality of bottled waters 400-1, 400-2, 400-3 utilizes a reusable container 401-1, 401-2, 401-3. Furthermore, each of the container 401-1, 401-2, 401-3 is attached with a unique individual machine-readable code C1, C2, C3. The unique individual machine-readable code C1, C2, C3 is pre-assigned to the container 401-1, 401-2, 401-3 based on at least one batch information of the corresponding bottled water 400-1, 400-2, 400-3. In an example, the batch information includes identification number (ID), water source, water hardness, quality standards, manufacturer, treatment, bottling date, and etc. In another example, the unique individual machine-readable code is corresponding to an identification number of the container which is used for tracking the container.

As shown in FIG. 2A, the server 100 and the devices 200-1, 200-2 are operated by the service provider, while the destination locations 300-1, 300-2, 300-3, 300-4 are houses or offices where the customer located or the places where the customer intended to deliver the bottled water. The trucks 201-1, 201-2 may be operated or hired by the service provider. The trucks 201-1, 201-2, for example, could be a truck or a van that is able to load a plenty of bottled waters. The water source 203 is a place where can supply purified water and fill the purified water in the containers 401-1, 401-2, 401-3 to produce the bottled water. Each of the trucks 201-1, 201-2 is driven by the transport driver, which is dispatched by the service provider to go to the water source 203 to load a predetermined amount of bottled waters and distribute them to the devices 200-1, 200-2. As described herein, the transport driver refers to a driver operating the trucks 201-1, 201-2 and a transport driver refers to a driver operating the vehicles 201-1, 201-2. According to some examples, the drivers are person. While in other examples, an autonomous vehicle may be used so that the drivers may refer to electronic devices. The trucks 201-1, 201-2 are equipped with the truck driver devices, respectively.

Referring back to FIG. 2A, prior to delivering the bottled waters 400 to the customer, the service provider schedules the trucks 201-1, 201-2 to arrive at the water source 203 to transport a plurality of bottled waters 400. The trucks 201-1, 201-2 deliver the bottled waters 400 to the devices 200-1, 200-2, respectively. Then the bottled waters 400 could be stored in the devices 200-1, 200-2.

As shown in FIG. 2B through FIG. 2D, the vehicles 500-1, 500-2, 500-3, 500-4, 500-5 may be a vehicle that operated by an individual, operated semi-autonomously or fully autonomously, operated remotely, or any combination thereof. The vehicles 500-1, 500-2, 500-3, 500-4, 500-5, for example, could be any type/size of car or motorcycle (e.g., sedan, sport utility vehicle, electric vehicle, limousine, etc.) to participate in the bottled water delivery. The vehicles 500-1, 500-2, 500-3, 500-4, 500-5 are equipped with the delivery driver devices, respectively. The delivery driver of the vehicles 500-1, 500-2, 500-3, 500-4, 500-5 could obtain a plurality of bottled waters 400-1, 400-2, 400-3 from the devices 200-1, 200-2 and distribute the bottled waters 400-1, 400-2, 400-3 to the destination locations 300-1, 300-2, 300-3, 300-4.

In an example, a plurality of service regions A, B are defined based on a given distance from where the devices 201-1, 201-2 are located. The destination locations 300-1, 300-2, 300-3, 300-4 are houses or offices where the customer located within the service region A and the destination locations 300-5, 300-6, 300-7, 300-8 are houses or offices where the customer located within the service region B. For instance, service region A may represent Berkeley City and service region B may represent Concord City in California.

Below is the description of a flow for providing the bottled water delivery in the automated bottled water reordering service as shown in FIG. 1, according to one or more embodiments.

After the server 100 receives a data associated with the replenishment order, the server 100 determines a pool of candidate delivery drivers satisfies a criterion based on a current location of the candidate delivery drivers, a capacity of a vehicle of the candidate delivery drivers, locations of a plurality of available collection, storing and distribution devices 200-1, 200-2 and the destination location 300-1, 300-2, 300-3, 300-4, 300-5, 300-6, 300-7, 300-8. The replenishment order may indicates a customer information, a destination location, a quantity of bottled water and a type of water for the bottled water delivery service. As shown in FIG. 2B, the candidate delivery drivers may include the drivers of the vehicles 500-1, 500-2, 500-3, 500-4, 500-5.

As illustrated, for example, in FIG. 2B, when the customer makes the replenishment order to ask the service provider to deliver the bottled water 400 to the destination location 300-1, 300-5, the drivers of the vehicles 500-1, 500-5 may be selected. The server 100 sends an instruction to the drivers of the vehicles 500-1, 500-5 to dispatch the selected delivery driver with the particular vehicle 500-1, 500-5 to the designated collection, storing and distribution devices 200-1, 200-2, as shown in FIG. 2C. After picking up the bottled waters 400 from the devices 200-1, 200-2, the delivery driver with the vehicle 500-1, 500-5 respectively move to the designated destination location 300-1, 300-5, as shown in FIG. 2D.

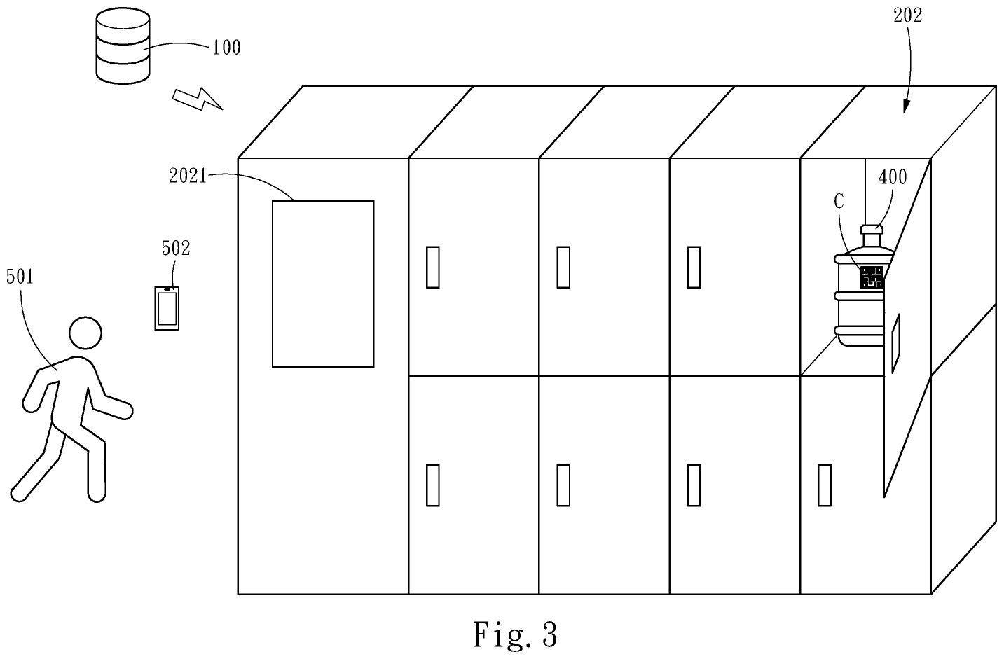

In an example, each of the devices 200-1, 200-2 includes a group of storage devices 202-1, 202-2 with a lock installed in a station, a warehouse, a storage area, or any other similar facility, to which the present invention is not limited. FIG. 3 is an example of the collection, storing and distribution devices, according to one or more embodiments. As shown in FIG. 3, the storage devices 202 are a plurality of keyless smart lockers with a control panel 2021 installed in a warehouse to store a plurality of bottled waters 400. The storage devices 202 are wirelessly connected to the server 100 and are be administered from the server 100. When a delivery driver 501 is picking up the bottled waters 400, the delivery driver 501 may unlocked (or activated/controlled) the storage device 202 by using digital password code, face recognition, or fingerprint through the control panel 2021. Alternatively, the delivery driver 501 may unlocked (or activated/controlled) the storage device 202 by using contactless technology (such as NFC or Bluetooth) through the communication between the storage device 202 and a delivery driver device 502.

When the delivery driver 501 arrives the designated collection, storing and distribution device. The server 100 authenticates whether the delivery driver 501 is the one that received the instruction. In an example, the authentication is a process of verifying whether the delivery driver 501 is the one received the instruction by scanning a code (QR code or bar code) shown with the delivery driver device 502 or using NFC. The storage device 202 may be installed with a scanner or a NFC reader to process the authentication. Once the authentication is successful, the storage device 202 will allow the delivery driver 501 to get the bottled water. In an example, the locker will open up when the authentication is successful.

In the present disclosure, each of the bottled waters 400-1, 400-2, 400-3 is pre-assigned the unique individual machine-readable code C1, C2, C3 by attaching onto a container 401-1, 401-2, 401-3 thereof. In an example, the unique individual machine-readable code is a QR code. By this way, each of the container or the bottled waters 400-1, 400-2, 400-3 became distinguishable and could be tracked and identified so the service provider can improve the management of the bottled water delivery service.

In addition to the flow described above, the service provide may deliver the bottled water 400 by other possible ways. In an example, the bottled water 400 could be delivered to the designated destination location 300-1, 300-5 from the water source 203 by the trucks 201-1, 201-2. In another example, the bottled water 400 could be delivered to the designated destination location 300-1, 300-5 from the devices 200-1, 200-2 by a delivery vehicle operated or hired by the service provider.

In the example, monitoring the drinking water consumption is performed by the flowmeter. In another example, the sensor may be an infrared liquid level sensor which detected the water level of the bottled water 400 so as to obtain the drinking water consumption. Alternatively, the sensor may be a scale device to weight the bottled water 400 to obtain the drinking water consumption. For example, by tracking a weight of the bottled water 400 at regular intervals, the drinking water consumption could be obtained. When using the flowmeter, the drinking water consumption is a total volume flowed over a period started from the first bottled water 400.

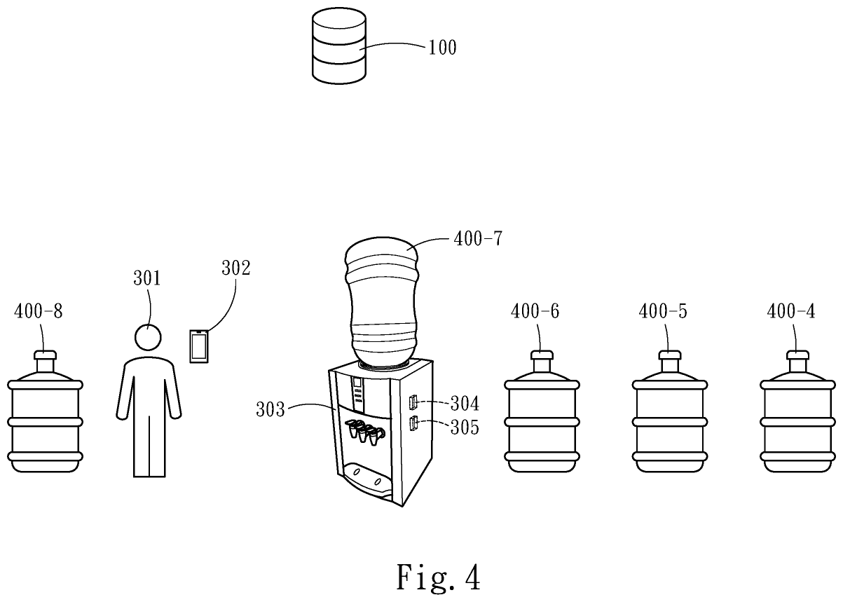

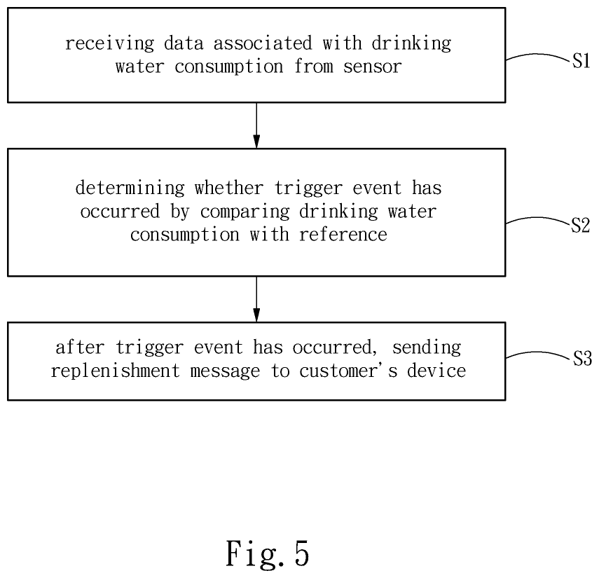

FIG. 4 illustrates an example for the automated bottled water reordering service, according to one or more embodiments. FIG. 5 illustrates a flow diagram of an example for the automated bottled water reordering service, according to one or more embodiments. The bottled water is 5 gallon bottled water and is mounted on a water dispenser 303 with a sensor 304. The water dispenser 303 is a top loading water dispenser. The sensor 304 is a flowmeter.

In the example, the customer 301 ordered five bottled waters with a total volume of 25 gallon. The bottled waters 400-4, 400-5, 400-6 represent the spent bottled water, the bottled water 400-7 represents the one currently using, and the bottled water 400-8 represents the full one. Upon using, the sensor 304 periodically sends a data associated with the drinking water consumption back to the server 100 such that the server 100 can periodically receives the data. (S1)

The server 100 determines whether a trigger event has occurred by comparing the drinking water consumption with a reference upon receiving the data each time. (S2) The trigger event occurs if a difference between the drinking water consumption and the reference is less than a threshold. The reference and/or the threshold may be set by the customer or the service provider.

In the example, the reference may be a percentage of the total volume of the bottled waters in the pervious order and the threshold is zero. For a instance, the percentage is 80%. That is, the trigger event occurs if the drinking water consumption is greater than the reference (20 gallon). Then the server 100 will send a replenishment message to the customer device 302 for the customer 301 to confirm whether or not to place a replenishment order.

In another example, the system further includes a measurement device 305 mounted on the water dispenser 303 to detect a chemical property of the drinking water. The measurement device 305 may be a total dissolved solids (TDS) meter and/or a pH meter. Similarly to the sensor 304 described above, the measurement device 305 may further includes a wireless connection module to communicatively connected to the server 100 such that the server 100 and the measurement device 305 may receive and transmit a data associated with quality of the drinking water via the wireless interface. Alternative, the measurement device 305 may be incorporated into the sensor 304. In such way, the measurement device 305 can send a data associated with quality of the drinking water to the server 100.

In an example, if the drinking water has a TDS level higher than a standard level or a pH level out of a standard range. The server 100 will notify the customer 301 by sending a message, so the customer 301 may clean the water dispenser 303 or take further actions (e.g. swap a new bottled water or place a new order). In a further embodiment of the invention, the server 100 may notify the customer 301 regarding the drinking water consumption periodically so the customer 301 may know how many water him/her drinks during a period (e.g. per day). The notification may act as a reminder to remind the customer 301 to drink enough water.

Accordingly, the supplier can automatically notify the customer whether to places a new order for the bottled water when the drinking water of the customer is about to run out, so as to enhance the user experience and also improve the customer service. The customer can know when to place the next order for the bottled water by receive a reminder (the replenishment message) from the supplier, without counting how many bottled waters left or how much water still in the bottle by their own. Additionally, by sending the notification of the drinking water consumption periodically, the system can track the customer's hydration for health reasons.

What is claimed is:

1. A network computer system for providing automated bottled water reordering service based on monitored usage, comprising:
one or more processors of a network-accessible server; and
one or more memory resources storing program instructions when executed on the one or more processors, cause the server to:
receive, from a sensor which is adapted to monitor a drinking water consumption in a water dispenser of a customer, data associated with the drinking water consumption;
determining whether a trigger event has occurred by comparing the drinking water consumption with a reference;
after the trigger event has occurred, sending a replenishment message to a customer device for the customer to confirm whether or not to place a replenishment order;
receiving data associated with the replenishment order, wherein the replenishment order indicating a customer information, a destination location, a quantity of bottled water and a type of water for the bottled water delivery service;
determining a pool of candidate delivery drivers that can satisfy a criterion based on a current location of the candidate delivery drivers, a capacity of a vehicle of the candidate delivery drivers, locations of a plurality of available collection, storing and distribution devices and the destination location, wherein the collection, storing and distribution devices being situated at a particular location where the candidate delivery drivers can access and exchange bottled water; and
providing an instruction, according to the replenishment order, to a device of a selected delivery driver to dispatch the selected delivery driver with a particular vehicle to a designated collection, storing and distribution device and then a designated destination location after fetching bottled water from the designated collection, storing and distribution device.

2. The system of claim 1, wherein the trigger event occurs if a difference between the drinking water consumption and the reference is less than a threshold.

3. The system of claim 1, wherein the reference is a percentage of a total volume of the bottled waters in a pervious order.

4. The system of claim 1, wherein the server and the sensor receives and transmits the data via a wireless interface, and the wireless interface utilizes a protocol of at least one of a LoRaWAN, Bluetooth, \NTH, NFC, RFID, 3G, 4G, 5G, LTE or combinations thereof.

5. The system of claim 1, wherein when the selected delivery driver arrived the designated collection, storing and distribution device, further cause the one or more processors to authenticate an identity of an entity arriving the designated collection, storing and distribution device is the selected delivery driver received the instruction to allow removal of the bottled water from the designated collection, storing and distribution device.

6. The system of claim 1, wherein the sensor is a flowmeter, a infrared liquid level sensor or a scale device which is adapted to weight the bottled water.

7. A system for providing automated bottled water reordering service based on monitored usage, comprising:
a water dispenser connected with a replaceable bottled water for supplying a drinking water from the bottled water;
a sensor which is adapted to monitor a drinking water consumption in the water dispenser; and
a server communicatively connected to the sensor, the server including one or more processors and one or more memory resources storing program instructions when executed on the one or more processors, perform operations comprising:
receiving a data associated with the drinking water consumption from the sensor;
determining whether a trigger event has occurred by comparing the drinking water consumption with a reference;
after the trigger event has occurred, sending a replenishment message to a customer device for the customer to confirm whether or not to place a replenishment order of a bottled water delivery service.

8. The system of claim 7 wherein the server and the sensor receives and transmits the data via a wireless interface, and the wireless interface utilizes a protocol of at least one of a LoRaWAN, Bluetooth, WiFi, NFC, RFID, 3G, 4G, 5G, LTE or combinations thereof.

9. The system of claim 7, wherein the system further includes a measurement device mounted on the water dispenser to detect a chemical property of the drinking water.

10. The system of claim 9, wherein the measurement device is a total dissolved solids (TDS) meter and/or a pH meter.

11. The system of claim 7, wherein the sensor is a flowmeter, a infrared liquid level sensor or a scale device which is adapted to weight the bottled water.

12. The system of claim 7, wherein the trigger event occurs if a difference between the drinking water consumption and the reference is less than a threshold.

13. The system of claim 7, wherein the reference is a percentage of a total volume of the bottled waters in a pervious order.

14. A network computer system for providing automated bottled water reordering service based on monitored usage, comprising:
one or more processors of a network-accessible server; and
one or more memory resources storing program instructions when executed on the one or more processors, cause the server to:
receive, from a sensor which is adapted to monitor a drinking water consumption in a water dispenser of a customer, data associated with the drinking water consumption;
determining whether a trigger event has occurred by comparing the drinking water consumption with a reference;
after the trigger event has occurred, sending a replenishment message to a customer device for the customer to confirm whether or not to place a replenishment order of a bottled water delivery service.

15. The system of claim 14, wherein the server and the sensor receives and transmits the data via a wireless interface, and the wireless interface utilizes a protocol of at least one of a LoRaWAN, Bluetooth, RFID, 3G, 4G, 5G, LTE or combinations thereof.

16. The system of claim 14, wherein the sensor is a flowmeter, a infrared liquid level sensor or a scale which is adapted to weight the bottled water.

17. The system of claim 14, wherein the trigger event occurs if a difference between the drinking water consumption and the reference is less than a threshold.

18. The system of claim 14, wherein the reference is a percentage of a total volume of the bottled waters in a pervious order.
